(19) United States
(12) Patent Application Publication
(10) Pub. No.: US 2011/0140403 A1
(43) Pub. Date: Jun. 16, 2011

(54) Driver restraint system for the operator of a straddle carrier

(75) Inventors: Conrad Mueller, Zell am Main (DE); Thomas Brummer, Wuerzburg (DE)

(73) Assignee: Noell Mobile Systems GmbH, Wuerzburg (DE)

(21) Appl. No.: 12/807,019

(22) Filed: Aug. 26, 2010

(30) Foreign Application Priority Data
Dec. 11, 2009 (DE) 10 2009 057 796.3
Jan. 12, 2010 (DE) 10 2010 004 460.1

(51) Int. Cl. B60R 22/06

(52) U.S. Cl. 280/804

(57) ABSTRACT

A driver restraint system for straddle carriers has a driver's seat firmly disposed in its infrastructure transverse to the direction of travel. The seat is connected with a seat shell which can be deformed by the forces that occur if the straddle carrier tips over, and which can be displaced in its position and braked with regard to the driver's cabin, in the direction of forces that occur. A belt roller is attached to the seat shell.

### CROSS REFERENCE TO RELATED APPLICATIONS

Applicants claim priority under 35 U.S.C. §119 of German Application No. 10 2009 057 796.3 filed Dec. 11, 2009 and German Application No. 10 2010 004 460.1 filed Jan. 12, 2010.

### BACKGROUND OF THE INVENTION

1. Field of the Invention

The invention relates to a driver restraint system for the operator of a straddle carrier. The invention can be used anywhere where straddle carriers have cabins for the operator.

2. The Prior Art

Straddle carriers are usually controlled by a person and are built to be very high and narrow. The support system of straddle carriers essentially consists of a narrow, high portal, is mounted on rubber-tired, freely steerable wheels, and carries a lifting mechanism, so that it is possible to drive over the containers to be transported even when they are stacked to a significant height. The load handling device for the containers is guided and disposed between the supports of the portal. This device picks the container up and sets it down again at a suitable location after transport. The operator's or driver's cabin is disposed in such a manner that the operating personnel can control and monitor the lifting process well, and this has the result that the cabin is disposed up to 12 m above the ground. Various possibilities are known for getting into the cabin.

The possibilities of getting into the cabin include ladders, steps along the supports, or cabins that can be moved along the supports, as described in German Patent Application No. DE 203 20 967 U1.

Straddle carriers are vehicles that are suitable for moving at a high speed with or without a load, and are able to accelerate and to brake. Despite electrical operator/assistance systems, the machines are at risk of tipping, due to inappropriate speed or acceleration, or by the weather conditions that occur not infrequently in harbors.

The risk of tipping can be restricted using electronic controls, but it cannot be avoided.

Cabins of straddle carriers have not only the unique feature that they are disposed very high up on the vehicle, but also that they have as good as possible a field of vision of the work area that lies underneath them. For this reason, viewing windows that reach from the top to the bottom are generally disposed in all directions in the cabin. If the vehicle tips, the driver restraint system has particular importance with this type of cabins, since it requires that the inertial forces that act on the driver during an impact must be absorbed by way of the belt system, or, in the event of an impact on the back, directly by the driver's seat, and passed into the support system of the cabin by way of the belt system or seat. However, conventional seats do not always withstand the inertial forces that occur in the event of an impact from a great height. No driver restraint system for straddle carriers is known.

European Patent Application No. EP 1 245 487 A2, describes an improved belt restraint system and a roll-up device for a seat in an aircraft. These devices make it possible for the person strapped into the seat to rise up from the seat and perform tasks that occur at a distance from the seat.

German Patent Application No. DE 20 2007 016 156 U1 describes a straddle carrier for transporting and stacking freight containers, having an automatic steering, in which a driver restraint system having a driver's seat disposed transverse to the direction of travel, a back rest, a seat infrastructure, and a belt roller are disposed.

While this assembly is present in the vehicle, it is not described in the document itself.

German Patent Application No. DE 36 31 881 C2 describes a restraint device for a vehicle passenger, in which the strapped-in vehicle passenger is caught after a short spring path of the resilient seat cushion, on the basis of an adjustable seat wedge, and his posterior does not submerge into the seat cushion any further once a pre-determined stress has been reached. Once the stress limit has been reached, plastic deformation of the seat wedge takes place, with the performance of shape change work, and a slightly increasing seating depth. Sheet-metal constructions, pipe constructions surrounded by foam, plastic shells, etc., can be used as deformable seat parts. The seat cushion is disposed in a lower seat frame that forms the seat shell and on which the wind-up roller with a tension element, a cable, and a lever mechanism are disposed.

The lower seat frame, which represents the seat shell, is not deformable, but it does contain a mechanism with which the seat cushion can be deformed.

German Patent Application No. DE 102 53 248 A1 describes the safety device of a motor vehicle, having a belt system and a seat device. The belt system is attached to the seat device by several first attachment elements, and the belt system or the seat device is connected with the body of the motor vehicle by means of a number of second attachment elements. For rescuing vehicle passengers, the second attachment elements are divisible, so that injured persons can be removed from the passenger cell without injuring them further.

German Patent Application No. DE 196 16 915 C1 describes a device for limiting the belt force of a belt restraint system in a vehicle, whereby at least one plastically deformable part of the seat structure is disposed in the force flow between the belt connection point on the seat and the vehicle body, and when a pre-determined stress is exceeded, the part is plastically deformed and the plastic deformation is limited to a pre-determined value. These parts are situated on the seat attachment below the seat device.

A similar restraint system is described in German Patent Application No. DE 102 55 910 A1, whereby a restraint belt is connected with a roll-up device, for example a cable roller, and the roll-up device functions like the belt roller of conventional seat belts.

### SUMMARY OF THE INVENTION

It is therefore an object of the invention to develop a driver restraint system that guarantees that the effect of an impact on the operator is clearly reduced in the event of tipping or a collision of a straddle carrier, when the cabin hits the ground or a different obstacle from a great height.

This object is accomplished by a driver restraint system for straddle carriers, in which the driver sits transverse to the direction of travel. Tipping toward the inside of a curve and toward the outside of a curve is considered. In the first case, the driver falls into the belts; in the second, into the seat.

The restraint system consists of the driver's seat with back rest and infrastructure, a belt system, and a shell-like body composed of a suitable material, for example steel, which is connected with a guide, if necessary, which permits movement in the direction of the inertial forces, against resistance. The shell-like body is referred to as a seat shell hereinafter.

The driver's seat, with its infrastructure, stands in the seat shell and is firmly connected with it. The driver's seat can be displaced and adjusted, relative to the seat shell, for the purpose of setting an ergonomically advantageous work position. The belt ends are firmly attached to the seat shell.

The greater delays that occur in the event of an impact of the cabin on the ground are reduced to a measure that is tolerable for human beings, in that
in the event of an impact toward the outside, it considered that the driver's seat will not withstand the stresses and will be destroyed, and the driver, together with the back rest, the seat, and possibly the seat infrastructure, will fall into the seat shell,
in the event of an impact toward the inside, the seat belts are guided directly into the seat shell.

The seat shell deforms under the effect of the forces that occur in this connection, so that energy is absorbed when this happens.

Fundamentally, the delays on the driver are first absorbed by the belt system and by the driver's seat, then by the seat shell, and, during the further course of events, by the braking and/or delay system of the rails on which the seat shell is disposed in the driver's cabin.

The seat shell is configured in such a manner that the greatest possible amount of energy can be absorbed. This must be determined by means of individual design, using known FE analysis methods.

If the straddle carrier tips outward, the driver will fall into the seat. If this seat does not withstand the stress and falls into the seat shell, the seat shell will deform and can furthermore move in the rails, against resistance.

If the straddle carrier tips inward, the driver will fall into the belts or belt, which is/are attached to the seat shell with all its/their ends (both the belt roller and the two ends of the lap belt). This shell in turn will deform and can move in the rails, against resistance.

The seat shell can be attached to the cabin, for example to the floor of the cabin, by means of rail systems. The shape-fit rail system can represent a tongue/groove connection in such a form that a carriage moves on a rail that narrows in cross-section, and the force is absorbed by means of plastic and/or elastic deformation of the rail, in order to brake the carriage. Narrowing of the rails can take place in that the distance between two rails becomes less in the direction toward their ends, so that they are bent toward one another when the carriage is moved. However, narrowing can also take place in that the distance between the top and the underside of each U-shaped rail is decreased toward the ends.

In another embodiment, the tongue/groove connection is disposed on the rail in the form of a brake shoe system, on one or both sides.

Another possibility consists in that the seat shell, which is disposed on a carriage, is braked by way of a braked axle and a wire that unwinds, which has a suitable diameter, or by a cable or equivalent means.

Furthermore, a compression pipe can be provided, in order to brake the displacement of the seat shell. The placement of the compression pipe can take place at a suitable location, for example on the one side, the other side, or both sides of the rail system.

A combination of these measures with other suitable measures for braking the carriage is also possible.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a restraint system for straddle carriers, with the driver's seat and seat shell on a rail;

FIG. 2 shows the driver restraint system for straddle carriers, in a front view, with a shaft and an unwinding wire; and

FIG. 3 shows the driver restraint system for straddle carriers, in a view from below, with a shaft, an unwinding wire, and a compression pipe on the rail system.

### DETAILED DESCRIPTION OF THE PREFERRED EMBODIMENT

Referring now in detail to the drawings, FIG. 1 shows a driver's seat 4 with a back rest 6, a cable 3, and a belt roller 7, which is attached to a seat shell 1. Driver's seat 4 is connected with seat shell 1 by way of cables 3. Seat 4 is adjustable in height and disposed on infrastructure 2. Seat 4 with seat shell 1 can be adjusted, relative to the foot pedals, by way of rails, depending on the size of the operator. Seat shell 1 is disposed on a carriage that moves along rail 8.

In the case of an impact in the viewing direction of the vehicle driver (toward the inside), the vehicle driver is at first held back by the belt. Since, in the present case, this is a three-point belt, the driver is held back by a belt that is attached at three points. Furthermore, cables 3 are disposed on seat 4. These catch the seat parts connected with them, in the event that these parts come loose from their infrastructure after the impact. When a certain force on the belt is exceeded, the seat shell is deformed and can move on rails 8, against a resistance, thereby absorbing further forces.

In the event of an impact from behind (tilting toward the outside), the driver falls into driver's seat 4. If this seat does not withstand the stress and falls into seat shell 1, seat shell 1 is deformed by the forces that occur. Seat shell 1 can then move on rail 8, together with seat 4, and is braked on it, the braking being possible in different ways.

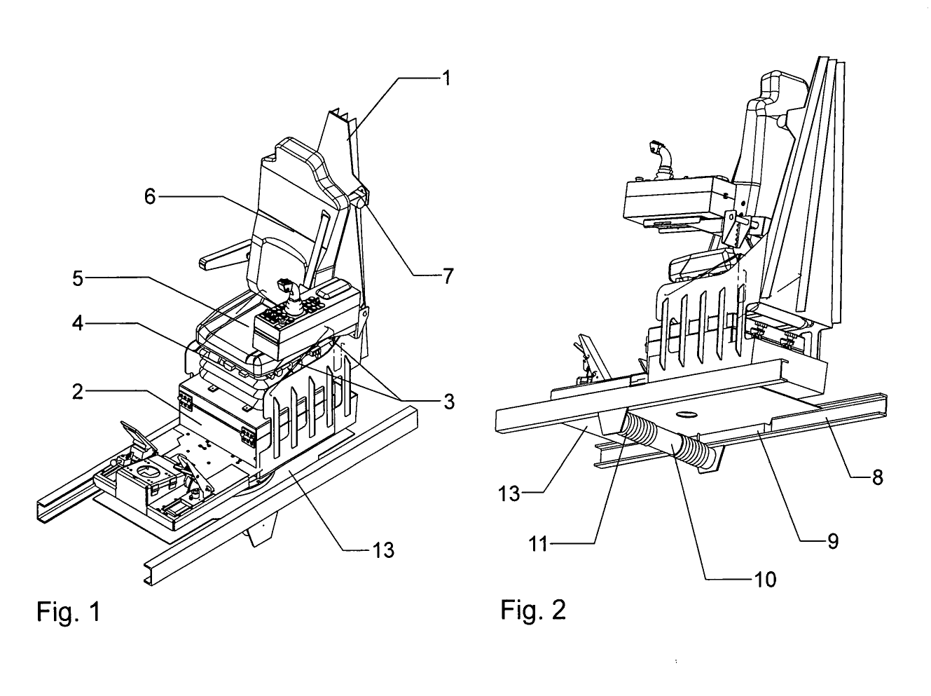

One preferred embodiment for braking carriage 13 relative to rail 8 is shown in FIG. 2, whereby rail 8 has a U shape and a braked axle 10 having an unwinding steel wire 11 is provided.

It can be seen that one end of steel wire 11 is disposed on the carriage 13, so that the carriage 13 can move, with seat 4 and seat shell 1, for a defined distance along rail 7, until its movement comes to a stop, due to axle 10. In addition, brakes 9 are disposed in rail system 8, on both sides, so that additional braking can take place.

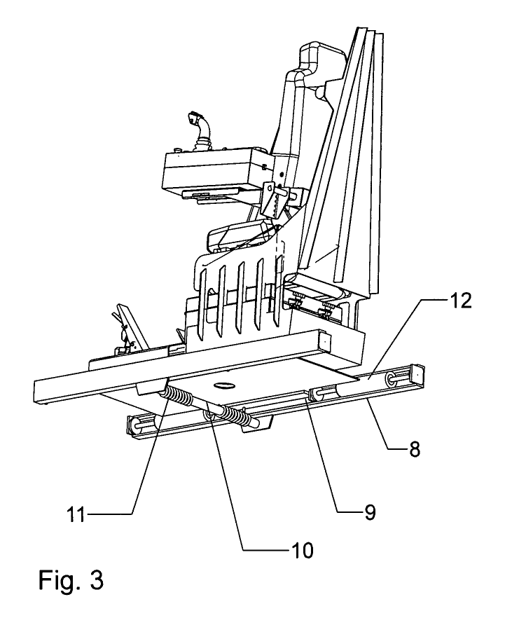

FIG. 3 shows the driver restraint system in a view from below, in which an axle 10 having an unwinding steel wire 11 is provided, and two compression pipes 12 in rail system 8 additionally serve as a braking system.

Compression pipes 12 have a pre-determined wall diameter and are plastically deformed when a pre-determined force is exceeded.

Accordingly, while only a few embodiments of the present invention have been shown and described, it is obvious that many changes and modifications may be made thereunto without departing from the spirit and scope of the invention.

What is claimed is:

1. A driver restraint system for straddle carriers, comprising:
a driver's seat adapted to be connected to an infrastructure of the straddle carrier facing transverse to a direction of travel;
a seat shell connected to the seat, said seat shell being deformable by forces that occur if the straddle carrier tips over, and which is displaceable in a direction of the forces that occur, and brakeable; and
a belt roller attached to the seat shell.

2. The driver restraint system according to claim 1, wherein at least one spring, one rubber band, or one cable is disposed between the driver's seat and seat shell.

3. The driver restraint system according to claim 1, wherein the seat shell is disposed on a carriage on a rail system.

4. The driver restraint system according to claim 3, wherein the carriage is disposed on the rail system by a tongue/groove connection.

5. The driver restraint system according to claim 3, wherein the carriage has a rail brake shoe system and the rails are U-shaped.

6. The driver restraint system according to claim 3, wherein the carriage has an axle and an unwinding wire for braking the seat shell.

7. The driver restraint system according to claim 3, wherein the carriage has one or more compression pipes for braking the seat shell.
